(19) United States
(12) Patent Application Publication
(10) Pub. No.: US 2017/0132681 A1
(43) Pub. Date: May 11, 2017

(54) COMPUTER-IMPLEMENTED METHODS AND SYSTEMS FOR IDENTIFYING PRODUCTS PURCHASED BY INDIVIDUAL CUSTOMERS AT DIFFERENT MERCHANTS

(71) Applicant: MasterCard International Incorporated, Purchase, NY (US)

(72) Inventors: Rohit Modi, New Delhi (IN); Ashutosh Kumar Gupta, Varanasi (IN); Prakash Mayank, Uttarakhand (IN)

(21) Appl. No.: 15/299,977

(22) Filed: Oct. 21, 2016

(30) Foreign Application Priority Data
Nov. 6, 2015 (SG) 10201509207T

(51) Int. Cl. G06Q 30/06; G06Q 20/20

(52) U.S. Cl. CPC G06Q 30/0613; G06Q 30/0631; G06Q 20/202

(57) ABSTRACT

A computer-implemented method is described for identifying products purchased by individual customers at different merchants. The method comprises: receiving product purchase information from two or more merchants in a pre-defined merchant group; receiving transaction data for a plurality of customers in a pre-defined customer group; comparing details of the product purchase information with details of the transaction data to identify the product purchases associated with individual transactions and storing the association in a database; and extracting information from the database for an individual customer or for each customer in the pre-defined customer group to determine the products the customer(s) purchased from each merchant.

### CROSS-REFERENCE TO RELATED APPLICATION

This application is a U.S. National Stage filing under 35 U.S.C. §119, based on and claiming benefit of and priority to SG Patent Application No. 10201509207T filed Nov. 6, 2015.

### SUMMARY OF THE INVENTION

The present invention relates to computer-implemented methods and systems for identifying products purchased by individual customers at different merchants.

### BACKGROUND OF THE INVENTION

A problem faced by the retail industry is that there is currently no satisfactory way of identifying customer buying preferences across multiple different stores. While merchants can obtain stock keeping unit (SKU) level information for individual customers coming to their own stores, there is no way by which one merchant can obtain knowledge of the buying habits of the same customers at other stores (in particular, their competitors). There is therefore no current way by which merchants can obtain a holistic view of a customer's spend.

This problem makes it difficult for merchants to retain customers (e.g. as the merchants do not know what the customers are buying elsewhere). It also makes it difficult for merchants to obtain or develop customer loyalty.

Currently, product assortment and product placement in a store is based on an analysis of the customer spend at that particular store, without taking into consideration the buying habits of the same customers at other merchants. However, stocking the right products and brands, together, at the right time can be crucial in obtaining customer loyalty.

It is therefore an aim of the present invention to provide computer-implemented methods and systems for identifying products purchased by individual customers at different merchants.

### SUMMARY OF THE INVENTION

In accordance with a first aspect of the invention there is provided a computer-implemented method for identifying products purchased by individual customers at different merchants comprising:
a) receiving product purchase information from two or more merchants in a pre-defined merchant group;
b) receiving transaction data for a plurality of customers in a pre-defined customer group;
c) comparing details of the product purchase information with details of the transaction data to identify the product purchases associated with individual transactions and storing the association in a database; and
d) extracting information from the database for an individual customer or for each customer in the pre-defined customer group to determine the products the customer(s) purchased from each merchant.

Thus, embodiments of the present invention provide a computerised method for extracting purchasing data across multiple merchants (e.g. retailers) by tracking the spend patterns of individual customers. At present, payment card operators (such as MasterCard™) only have access to transaction level data which does not include details of the individual products purchased. On the other hand, individual merchants may monitor product purchases (e.g. through POS devices) and store basket-level data comprising the identification of each individual product purchased in a single transaction. However, each merchant will only have access to products purchased together at their particular store. Individual merchants will not have access to any data regarding products purchased together at any other stores (e.g. their competitors) and nor will they be able to determine which of their customers also bought products in other stores and what they bought there (e.g. in comparison to what the customer bought in the first merchant). Embodiments of the invention overcome these present limitations by combining transaction level data with product purchase information so as to identify individual customers and their spending habits with multiple merchants.

It should be understood that the term product is used throughout this specification to denote any goods or services. It is therefore not limited to physical products and may include services such as spa treatments, hair-dressing or other beauty services, transport or tourism services, entertainment or leisure activities, bar or restaurant services etc.

The method may further comprise analysing the products purchased across the merchants to provide data and/or recommendations to said merchants.

The data provided to merchants may be useful in areas such as product assortment, inventory management and design of offers and campaigns. For example, the data may be used to recommend product combinations to merchants to help drive the profitability of the merchant.

In one embodiment, the analysing step may comprise determining which products are most commonly purchased from one merchant and which related or complementary products are most commonly purchased from another merchant (either by an individual or by a pre-defined customer group) so that this data and/or one or more recommendations based on this data can be made to one or more of the merchants. The recommendations may comprise one or more of: stocking both items at the same time; locating both items next to or near to each other in store; bundling the items together; or offering a discount if the items are bought together.

Product purchase information may comprise stock keeping unit (SKU) data including one or more of the following: transaction key, store name, store location, individual key, store ID, date of purchase, time of purchase, basket ID, basket total spend, total number of items purchased, number of each product purchased, product codes, product descriptions, individual product prices, any discounts or offers redeemed etc.

Transaction data may comprise date of transaction, time of transaction, customer ID, card number, transaction ID, merchant name and location, transaction amount etc.

The product purchase information may be obtained directly from a merchant or through an intermediary.

The pre-defined merchant groups may be based on one or more of location, vicinity to other merchants (e.g. stocking complementary products or the same or similar products or product categories), industry, product type, price range, opening hours (e.g. 9-to-5 or 24/7) or target customer groups.

The pre-defined customer groups may be based on one or more of location (e.g. for home, workplace, usual shopping mall/area), gender, age, marital status, number/age of dependents, profession, income bracket, typical monthly/quarterly/annual spend, typical industry spend, etc. This data may be obtained directly from the customer (e.g. if they participate in a survey) or from a data supplier.

The comparison may comprise filtering the transaction data to identify all transactions from a particular merchant within a pre-defined time frame (e.g. 1 hour, 1 day, 1 week, 1 month or 1 year, or a part thereof, such as during the day, in the evening, on weekdays, on weekends) and filtering the product purchase information for that particular merchant over the same time frame. The transaction amounts and basket total spends may then be compared to match the product purchase information to the transaction data.

The analysis step may comprise identifying the products most commonly purchased from each merchant and/or identifying a typical amount or value of products purchased from each merchant.

The data may be presented to one or more of the merchants in terms of its market share of particular products or product categories.

Advantages of embodiments of the invention are that the data obtained may be used to increase sales through a range of techniques including identification of new products, better product placement, improved product bundling, and identification of better timing or types of offers to provide to customers.

The method may be implemented by a server or a computerised network of devices comprising a server or other computer processor.

The step of receiving product purchase information may comprise an electronic point of sale device (ePOS) in operation at a merchant, transmitting said product purchase information to a product database accessible by the server. The ePOS may transmit the information in real-time (i.e. at the time each purchase is made). Alternatively, the ePOS may store the information and subsequently transmit the information to the product database. In which case, the information may be transmitted in batches either at pre-defined times or intervals or upon operator instruction.

The step of receiving transaction data may comprise a payment card operator or bank transmitting said transaction data to a transaction database accessible by the server. The payment card operator or bank may transmit the data in real-time (i.e. at the time of each transaction). Alternatively, the payment card operator or bank may store the data and subsequently transmit the data to the transaction database. In which case, the data may be transmitted in batches either at pre-defined times or intervals or upon operator instruction.

According to a second aspect of the invention there is provided a computer system for implementing the method according to the first aspect of the invention, comprising:

a processor configure to:
a) receive product purchase information from two or more merchants in a pre-defined merchant group;
b) receive transaction data for a plurality of customers in a pre-defined customer group;
c) compare details of the product purchase information with details of the transaction data to identify the product purchases associated with individual transactions and store the association in a database; and
d) extract information from the database for an individual customer or for each customer in the pre-defined customer group to determine the products the customer(s) purchased from each merchant.

According to a third aspect of the invention there is provided a non-transitory computer program product comprising instructions, stored on a tangible data-storage device, for a processor to carry out the method according to the first aspect of the invention.

### BRIEF DESCRIPTION OF THE DRAWINGS

An embodiment of the invention will now be described for the sake of example only with reference to the following drawings, in which:

FIG. 1 shows schematically a computerized network of electronic devices for performing a method which is a first embodiment of the invention;

FIG. 2 shows a flow diagram for the method of to the first embodiment of the invention;

FIG. 3 shows a more detailed flow diagram for an embodiment of the invention; and

FIG. 4 shows a block diagram of the technical architecture of the server in FIG. 1.

### DETAILED DESCRIPTION OF THE EMBODIMENTS

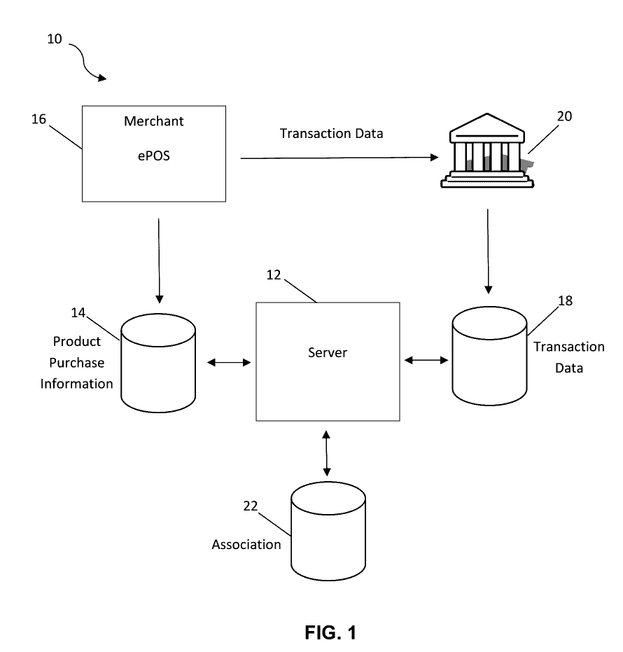

FIG. 1 shows a computer system 10 configured for implementation of an embodiment of the invention. The system comprises a server 12 arranged to communicate (e.g. over a network) with a product database 14 that comprises product purchase information for each transaction performed by an electronic point of sale (ePOS) device at a merchant 16. Although only one merchant 16 is illustrated in FIG. 1, it should be understood that product purchase information will be obtained from a number of different merchants 16 in the same way as described above such that the product database 14 will comprise data from each of the different merchants 16. Alternatively, the server 12 may be configured to obtain product purchase information from a number of different product databases 14, each one being associated with one or more different merchants 16.

The server 12 is also arranged to communicate (e.g. over a network) with a transaction database 18 that comprises transaction data provided by a payment card operator or bank 20, which records transaction information obtained from a number of merchants 16 when payments are made over an electronic payment network (not shown).

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

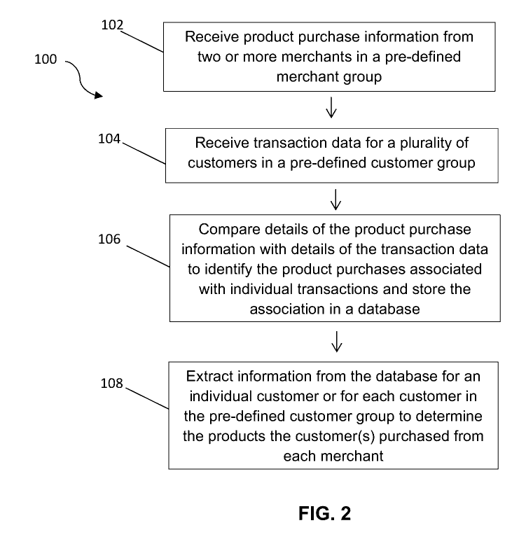

The server 12 comprises a processor configured to implement the method 100 illustrated in FIG. 2 which comprises the following steps:
Step 102: receive product purchase information from two or more merchants 16 in a pre-defined merchant group;
Step 104: receive transaction data for a plurality of customers in a pre-defined customer group;
Step 106: compare details of the product purchase information with details of the transaction data to identify the product purchases associated with individual transactions and store the association in a database 22; and
Step 108: extract information from the database 22 for an individual customer or for each customer in the pre-defined customer group to determine the products the customer(s) purchased from each merchant 16.

The server 12 may communicate with each database 14, 18, and 22 via a wireless connection (e.g. 3G, 4G, Wi-Fi or Bluetooth) or a wired connection. It should be understood that although three separate databases are illustrated in FIG. 1, two or more of them may be combined into a single database accessible by the relevant data providers.

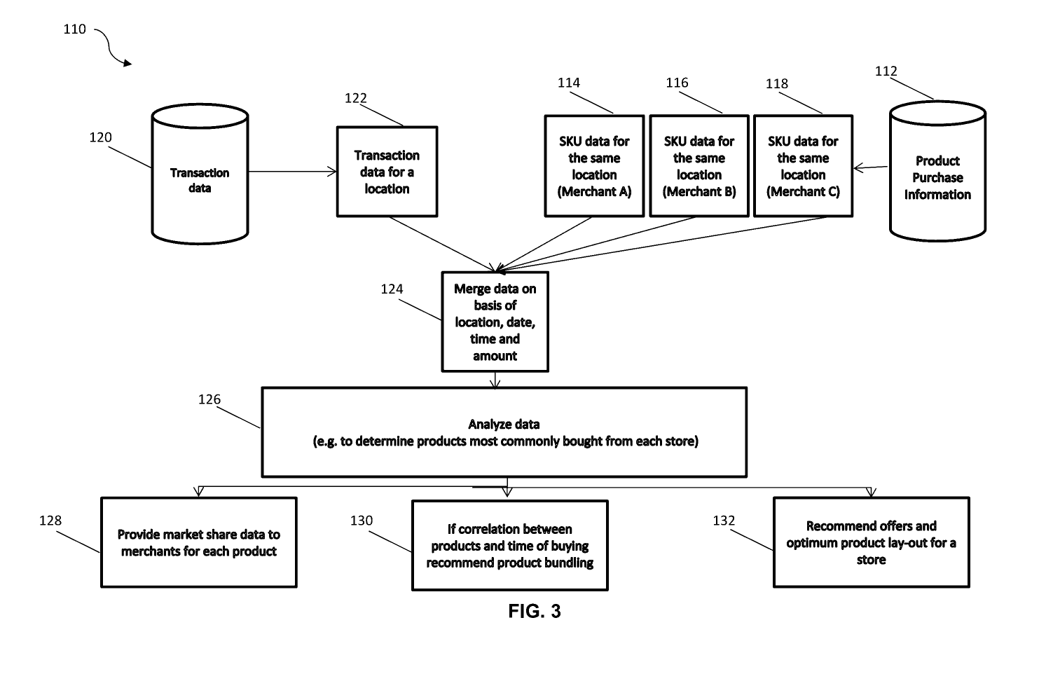

FIG. 3 shows a more detailed flow diagram for an embodiment of the invention. In this case, the product purchase information in the product database 112 comprises SKU level data from 3 merchants A, B, C (114, 116, 118) in the same locality (e.g. in the same town or area of a city) and in the same industry (e.g. supermarkets). Similarly, the transaction data in the transaction database 120 is filtered to identify transaction data for a group of customers 122 in the same locality. Further segmentation of the customer transaction data may be applied as desired (e.g. based on customer demographics, income bracket and typical spend amounts per industry).

The subset of customer transaction data 122 is then merged in step 124 with the product purchase information for each of the merchants 114, 116, 188 by matching the date, time, location and transaction amounts to identify the products bought by each customer at each merchant. The combined data may then be stored in the association database 22 of FIG. 1.

In step 126, analysis of the data in database 22 is performed. This analysis may be dependent on the information required by the merchants. As an example, the analysis may comprise determining the products most commonly bought from each of the merchants by this particular group of customers.

In step 128 the data is provided to the merchants in the form of a market share for each product identified.

In step 130 the data is analysed to determine a correlation between products and buying time which suggests that such products are commonly bought together and the merchants may use this information to bundle products together.

In step 132 the data is used to recommend offers (e.g. for buying related items) and an optimum product lay-out for a store (e.g. to place items commonly bought together in close proximity).

It will be understood that many other forms of analysis may be performed and may other uses of the data may be made by the merchants once the combined transaction and product data has been determined by use of embodiments of the invention.

For example, in one embodiment of the invention we can identify a customer who regularly buys products from two merchants (e.g. merchant A and merchant B) and can analyse the SKU level data to find out what products are bought by the customer from merchant A and which products desired by the customer requires the customer to also purchase items from merchant B.

An extract of data typical of that which may be stored in the product database 14 is shown in table 1 below in which each unique Transaction key represents a different basket (i.e. transaction). In table 1, the Individual key is a unique identifier for the customer making the purchase, the Store ID is a unique identifier for the merchant store the customer is buying from, the Transaction date and time are, respectively, the date and time when the transaction occurred, the Product code is a unique code for the products bought, the Product spend is the total amount spent on the product for that transaction, the Total basket spend is the total spend on all items in the basket (i.e. transaction), the Total basket quantity is the total quantity of all items being purchase in the basket, and the Total product quantity is the quantity of each individual product bought in each basket.

TABLE 1
Sample product purchase information

| | | | | | | | Total | Total | Total |
|---|---|---|---|---|---|---|---|---|---|
| Transaction | Individual | Store | Transaction | Transaction | Product | Product | Basket | Basket | Product |
| key | key | id | date | time | code | Spend | Spend | Quantity | Quantity |
| 2131313 | 34343 | 4544 | Jun. 10, 2010 | 17:00:00 | 6577767 | 2 | 10 | 4 | 1 |
| 2131313 | 34343 | 4544 | Jun. 10, 2010 | 17:00:00 | 2343243 | 5 | 10 | 4 | 2 |
| 2131313 | 34343 | 4544 | Jun. 10, 2010 | 17:00:00 | 3242345 | 3 | 10 | 4 | 1 |
| 1242342 | 21345 | 2345 | Jul. 10, 2010 | 18:00:09 | 8789787 | 4 | 4 | 2 | 2 |
| 2345565 | 56789 | 2134 | Oct. 10, 2010 | 09:13:34 | 4567891 | 5 | 20 | 3 | 1 |
| 2345565 | 56789 | 2134 | Oct. 10, 2010 | 09:13:34 | 2345643 | 15 | 20 | 3 | 2 |

As explained above, the product purchase information is combined with the transaction data to identify what customers bought from different merchants. This data is then analysed to provide information and recommendations to merchants as detailed above.

TABLE 2
Sample Transaction data

| | | | | | Trans- |
|---|---|---|---|---|---|
| Card | Merchant | Transaction | Transaction | Merchant | action |
| Number | City | Date | Time | Name | Amount |
| 1789876 | Manhattan | Oct. 6, 2010 | 17:00:00 | Retailer A | 4 |
| 1789876 | Manhattan | Oct. 6, 2010 | 18:23:12 | Retailer B | 0.5 |

Table 2 shows an extract of typical data making up the transaction data for a particular customer. In table 2, the card number identifies the customer and the transaction data includes the transaction date, time, location (e.g. city), merchant name and transaction amount. This example shows two purchases made within 1 hour and 30 minutes at two different retailers (A and B). Table 3 below shows sample product purchase information obtained from retailer A and table 4 below shows sample product purchase information obtained from retailer B, at around the same time as the transactions in table 2.

As can be seen from these tables, the data from each of the retailers A, and B comprises the store name, city, transaction date, transaction time and total basket spend while the transaction data for the customer comprises the merchant name, transaction amount and transaction date and time. In accordance with an embodiment of the invention, the transaction data (table 2) is compared with the product purchase information from retailer A (table 3) to try to match the store name/Merchant name, transaction date, transaction time and total basket spend/transaction amount in order to identify the card number (i.e. customer ID) making a purchase from retailer A. This process is then repeated with the transaction data (table 2) and the product purchase information from retailer B (table 4) so as to identify the purchases made by the customer identified above, from retailer B.

This ability to track a customer's spending from merchant to merchant (at a product level) is unique. The product purchase information (also referred to as SKU level data) in tables 3 and 4 can be provided either directly by individual merchants or through an intermediary (e.g. running a loyalty scheme), while the transaction data in table 2 is obtained from a payment card operator or bank.

Based on such analysis for multiple customers across multiple retailers we can track customers from retailer A to other retailers (such as B, C, D etc.) so as to determine whether the customers are more likely to purchase milk from retailer A and visit another retailer (e.g. retailer B) to purchase breakfast cereal (for example). From this data it is possible to infer that retailer A either does not stock the desired cereal, it is not priced competitively when compared to retailer B or it is not located in an optimal location (e.g. close to the location of the milk).

TABLE 3
Sample product purchase information for Retailer A

| | | | | | | | | | | Total | Total | Total |
|---|---|---|---|---|---|---|---|---|---|---|---|---|
| Transaction | Store | Store | Individual | Store | Transaction | Transaction | Product | Product | Product | Basket | Basket | Product |
| Key | name | City | key | id | date | time | code | description | Spend | Spend | Quantity | Quantity |
| 2131313 | A | Manhattan | 34343 | 4544 | Oct. 6, 2010 | 17:00:00 | 6577767 | Milk | 1 | 4 | 3 | 1 |
| 2131313 | A | Manhattan | 34343 | 4544 | Oct. 6, 2010 | 17:00:00 | 2343243 | detergent | 2 | 4 | 3 | 1 |
| 2131313 | A | Manhattan | 34343 | 4544 | Oct. 6, 2010 | 17:00:00 | 3242345 | soap | 1 | 4 | 3 | 1 |
| 1242342 | A | Manhattan | 21345 | 4544 | Oct. 6, 2010 | 18:00:09 | 2343243 | juice | 2 | 2 | 2 | 2 |

TABLE 4
Sample product purchase information for Retailer B

| | | | | | | | | | | Total | Total | Total |
|---|---|---|---|---|---|---|---|---|---|---|---|---|
| Transaction | Store | Store | Individual | Store | Transaction | Transaction | Product | Product | Product | Basket | Basket | Product |
| Key | name | City | key | id | date | time | code | description | Spend | Spend | Quantity | Quantity |
| 22312345 | B | Manhattan | 23456 | 4678 | Oct. 6, 2010 | 18:23:12 | 54677 | cereal | 0.5 | 0.5 | 1 | 1 |

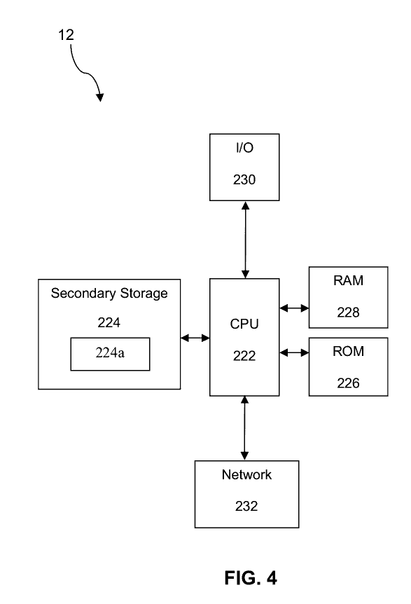

FIG. 4 shows a block diagram of a technical architecture of the server 12 in FIG. 1.

The technical architecture includes a processor 222 (which may be referred to as a central processor unit or CPU) that is in communication with memory devices including secondary storage 224 (such as disk drives), read only memory (ROM) 226 and random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, a program may be partitioned in such a way as to permit concurrent and/or parallel processing of the instructions of the program. Alternatively, the data processed by the program may be partitioned in such a way as to permit concurrent and/or parallel processing of different portions of a data set by the two or more computers. In an embodiment, virtualisation software may be employed by the technical architecture 220 to provide the functionality of a number of servers that is not directly bound to the number of computers in the technical architecture 220. In an embodiment, the functionality disclosed above may be provided by executing the program and/or programs in a cloud computing environment. Cloud computing may comprise providing computing services via a network connection using dynamically scalable computing resources. A cloud computing environment may be established by an enterprise and/or may be hired on an as-needed basis from a third party provider.

It will be understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

It will further be understood that embodiments of the invention provide a way of combining data from multiple sources (e.g. merchants) and extracting data which can be used to identify products purchased by individual customers at different merchants. The data can be used by merchants to increase sales (e.g. through identification of new products), to improve customer retention by providing the right products and brands at the right time, to improve product bundling through identification of relevant products not currently available in that one store, to improve product lay-out in stores and to design offers and their timing on the basis of the information obtained.

Whilst the foregoing description has described exemplary embodiments, it will be understood by those skilled in the art that many variations of the embodiments described can be made within the scope of the present invention, as defined by the claims.

1. A computer-implemented method for identifying products purchased by individual customers at different merchants, the method comprising:
a) receiving product purchase information from two or more merchants in a pre-defined merchant group;
b) receiving transaction data for a plurality of customers in a pre-defined customer group;
c) comparing details of the product purchase information with details of the transaction data to identify the product purchases associated with individual transactions and storing the association in a database; and
d) extracting information from the database for an individual customer or for each customer in the pre-defined customer group to determine the products the customer(s) purchased from each merchant.

2. The method according to claim 1 further comprising analysing the products purchased across the merchants to provide data and/or recommendations to said merchants.

3. The method according to claim 2 wherein the data provided to merchants is of use in areas comprising one or more of: product assortment, product placement, inventory management, product bundling, design of offers and campaigns.

4. The method according to claim 2 wherein the analysing step comprises determining which products are most commonly purchased from one merchant and which related or complementary products are most commonly purchased from another merchant.

5. The method according to claim 1 wherein the product purchase information comprises stock keeping unit (SKU) data including one or more of the following: transaction key, store name, store location, individual key, store ID, date of purchase, time of purchase, basket ID, basket total spend, total number of number of items purchased, number of each product purchased, product codes, product descriptions, individual product prices, any discounts or offers redeemed.

6. The method according to claim 1 wherein the transaction data comprises one or more of: date of transaction, time of transaction, customer ID, card number, transaction ID, merchant name and location, transaction amount.

7. The method according to claim 1 wherein the pre-defined merchant groups are based on one or more of location, vicinity to other merchants, industry, product type, price range, opening hours or target customer groups.

8. The method according to claim 1 wherein the pre-defined customer groups are based on one or more of location (for home, workplace or usual shopping mall/area), gender, age, marital status, number/age of dependents, profession, income bracket, typical monthly/quarterly/annual spend, typical industry spend.

9. The method according to claim 1 wherein the comparison comprises filtering the transaction data to identify all transactions from a particular merchant within a pre-defined time frame and filtering the product purchase information for that particular merchant over the same time frame.

10. The method according to claim 9 wherein transaction amount from the transaction data and basket total spend from the product purchase information are compared to match the product purchase information to the transaction data.

11. The method according to claim 1 wherein the step of receiving product purchase information comprises an electronic point of sale device (ePOS) in operation at a merchant, transmitting said product purchase information to a product database accessible by a computer system configured to implement the method.

12. The method according to claim 1 wherein the step of receiving transaction data comprises a payment card operator or bank transmitting said transaction data to a transaction database accessible by a computer system configured to implement the method.

13. A computer system comprising:
a processor configure to:
a) receive product purchase information from two or more merchants in a pre-defined merchant group;
b) receive transaction data for a plurality of customers in a pre-defined customer group;
c) compare details of the product purchase information with details of the transaction data to identify the product purchases associated with individual transactions and store the association in a database; and
d) extract information from the database for an individual customer or for each customer in the pre-defined customer group to determine the products the customer(s) purchased from each merchant.

14. A non-transitory computer-readable medium storing executable instructions for identifying products purchased by individual customers at different merchants, the instructions, when executed, cause one or more processors to:
receive product purchase information from two or more merchants in a pre-defined merchant group;
receive transaction data for a plurality of customers in a pre-defined customer group;
compare details of the product purchase information with details of the transaction data to identify the product purchases associated with individual transactions and store the association in a database; and
extract information from the database for at least one of (i) an individual customer and (ii) each customer in the pre-defined customer group to determine the products the customers purchased from each merchant.
